(19) United States
(12) Patent Application Publication
(10) Pub. No.: US 2019/0031249 A1
(43) Pub. Date: Jan. 31, 2019

(54) HEMLESS A-CLASS PANEL JOINING FOR VEHICLE BODY CONSTRUCTION

(71) Applicant: NIO USA, Inc., San Jose, CA (US)

(72) Inventors: Austin L. Newman, San Jose, CA (US); Nermin Mujcinovic, Fremont, CA (US)

(21) Appl. No.: 15/664,905

(22) Filed: Jul. 31, 2017

(51) Int. Cl. B62D 27/02; B62D 65/02; C09J 5/06; C09J 11/04

(52) U.S. Cl. CPC B62D 27/026; B62D 65/02; B60J 5/0463; C09J 11/04; C09J 5/06

(57) ABSTRACT

Methods and systems are disclosed for joining A-class panels with a body of a vehicle without the use of hemming. Vehicle outer panels are bonded to the vehicle structure (whether body structure or door/liftgate/hood structure) via an inductively cured adhesive joint. The process enables the body in white to be painted one color thereby minimizing painting costs and reducing any process risks. It also enables the outer panels to be painted separately and efficiently which increases throughput. The present disclosure does not require hemming at all. The present disclosure does not require spot-welds. A specialized structural epoxy adhesive filled with glass beads is laid onto the inner panel. The outer panel is then mounted onto the inner panel whereby the glass beads control the gap. The fixture used for this process incorporates an automated arm which swings the induction curing equipment over the outer panel to a precise gap.

### FIELD

The present disclosure is generally directed to vehicle body construction, in particular, toward systems and methods of hemlessly joining A-class panels.

### BACKGROUND

The traditional attachment of panels to body frames or the body in white of a vehicle happens before the outer panels of the vehicle are painted and involves bending a portion of the panel over another portion of the frame.

Hemming is the contemporary process of mechanically locking panels together. Hemming involves the application of an adhesive (i.e. a hem adhesive) and mechanically hemming, either in a die or via a robot, one panel onto another. This process is expensive to develop, causes sacrifices in styling and part design and is time consuming. Composite panels on low volume production vehicles or niche market vehicles are typically bonded together using two-part epoxy adhesives or induction cured adhesives. Applying that same technology to assemblies made of sheet-metal presents a number of challenges: adhesive read-through on the A-class panel, structural/durability and user experience concerns.

Currently sheet-metal vehicles are constructed such that the outer panels (known as A-class panels) are permanently attached to the vehicle body in white (BIW) in the body-shop which is the first stage in vehicle construction. Today's methods of joining outer panels onto a BIW result in a number of negative consequences ranging from excessive manufacturing costs, vehicle design limitations and constraints, an increased amount of time of manufacturing, an inefficient manufacturing timeline, an inefficient vehicle painting process, an unreliable joint strength, to a final product lacking aesthetic appeal.

### SUMMARY

It is with respect to the above issues and other problems that the embodiments presented herein were contemplated. The traditional attachment of panels to a vehicle body frame or body in white (“BIW”) (commonly referred to as a chassis) happens before the vehicle is painted and involves “hemming” the panels, a kind of a bending of a portion of each panel over a portion of the vehicle frame which creates a joint between the two.

As disclosed herein, a vehicle BIW may be constructed in a body shop without any outer panels attached. The BIW (commonly referred to as chassis) may then be e-coated and given a coat of paint. Next, the BIW may arrive in a general assembly (“GA”) part of a plant at which point parts or equipment may be installed in the BIW. For example, windows, electronics, and other parts or equipment may be installed in the BIW before any outer panels are attached to the BIW. After all the aforementioned parts or equipment are installed, the outer panels may be permanently bonded to the vehicle structure (whether body structure or door/liftgate/hood structure) of the BIW via an inductively cured adhesive joint.

The induction process may be performed in a number of ways. In some embodiments, a local inductive curing may be used. For example, two pieces of sheet metal may be held together with a bead of glue in between the sheet metal pieces. Coils may be placed on either side of the pieces of sheet metal. A magnetic field may be created between the coils. The magnetic field may heat up the sheets of metal and temperature-cure the adhesive. In some embodiments, each panel may be placed against a BIW in which certain contact points between the panel and the BIW may be coated with an adhesive. Using inductive curing, the panel may be permanently attached to the BIW without any requirement of a hemming process.

In some embodiments, coils used in the induction process may be custom formed to match the geometry or profile of each panel of the vehicle.

The process of using inductive curing to permanently attach the panels to the BIW may involve a number of parameters. An adhesive may be heated without burning or evaporating. The use of inductive curing to attach aluminum A-class panels to a BIW without read-through, or warping in the adhesive zone, and with adequate joint strength has not previously been performed. Contemporary methods of inductive curing panels of vehicles are performed only on composites.

In order to use inductive curing to attach aluminum A-class panels to a BIW without read-through, or warping in the adhesive zone, and with adequate joint strength, the gap to the coil itself must be properly tuned. In some embodiments, a ceramic mold may be created. For example, to make sure that the curing is appropriate, that the curing process does not burn through the adhesive and that there are no weak spots, a ceramic mold may be created to control the thickness for the efficiency of the curing process. In some embodiment, a panel, such as a door panel, may be placed on to a ceramic mold cradle to hold the door panel at a proper distance from the BIW. That distance between the door panel and the BIW may control the efficiency of the curing process to ensure adequate and efficient curing. Such a process has never before been used on sheet metal. The disclosed process is an easy process, but it also looks better and is also easier to manufacture.

This disclosure provides vehicle designers a way to avoid the use of hemming in the design of a vehicle. Contemporary methods of joining vehicle panels to a BIW involve hemming. Hemming vehicle panels is an intensive process and greatly prohibits the vehicle design and requires particular surface geometries.

Hemming is typically despised by designers because it inhibits the design process. The hemming process itself, requires specific features in the design of the vehicle, or creates barriers limiting design or styling freedom. For example, if vehicle designer seeks a complex body design, that design must be made considering the limitations of the hemming process. The limitations of the hemming process lead to compromises in the styling. The presently disclosed methods of adhesively joining panels to a vehicle body using induction curing provide a vehicle design studio with greater freedom and result in a cheaper product to manufacture, a quicker product to manufacture, more reliable, and a better-looking product.

Removing the requirement of hemming improves not only the manufacturing of a vehicle, but also the design process of the vehicle quite a bit very early on. Avoiding hemming helps avoid months of looping, of working with hemming supplies, etc. and so it speeds up the development process itself. By not hemming the panels, each BIW may be painted a single color and only the skins or panels may be painted in whatever color required by a customer. Which allows vehicle manufacturers to arrange these outer panels in a cube—and reduce paint shop costs by lowering the thermal mass which improves the efficiency of painting.

The disclosed process enables the BIW to be painted one color (for example, all black) thereby minimizing painting costs and reducing any process risks. It also enables the outer panels to be painted separately and efficiently (volumetrically) which increases throughput (reduces cycle time and cost).

Furthermore, a benefit is provided by the disclosed process in the vehicle manufacturing process itself. The present disclosure allows vehicle manufacturing operators to gain access to areas within the BIW. By allowing vehicle panels to be painted prior to being attached to a BIW, the overall vehicle manufacturing process is simplified and streamlined.

In some embodiments, the adhesive used in the process may be a specialized structural epoxy adhesive filled with glass beads (200-250 microns in diameter) which is laid onto the inner panel. The outer panel (also known as A-class) may then be mounted onto the inner panel whereby the glass beads control the gap. The fixture used for this process may incorporate an automated arm which may swing the induction curing equipment over the outer panel to a precise gap (such gap may depend on material type and thickness). The gap may be in some embodiments controlled via ceramic sheets which may touch the sheet-metal and encase copper tubing necessary for the induction curing equipment. The curing may in some embodiments be done in two ways: either spot curing or curing of the entire perimeter. The method may depend on the choice of the structural adhesive. The combination of the above elements ensures no read-through and a solid joint.

The term “computer-readable medium,” as used herein, refers to any tangible data storage medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read instructions. When the computer-readable medium is configured as part of a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The terms “determine,” “calculate,” and “compute,” and variations thereof, as used herein, are used interchangeably and include any type of methodology, process, mathematical operation, or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is an illustration of a hemming process as known in the art;

FIG. 2A is an illustration of a vehicle body in white in accordance with embodiments of the present disclosure;

FIG. 2B is an illustration of a vehicle door panel in accordance with embodiments of the present disclosure;

FIG. 2C is an illustration of a vehicle in accordance with embodiments of the present disclosure;

FIG. 3 is an illustration of a vehicle body in white with adhesive in accordance with embodiments of the present disclosure;

FIG. 4 is an illustration of a vehicle panel mounting system in accordance with embodiments of the present disclosure;

FIG. 5 shows a detail view of a vehicle mounting system in accordance with embodiments of the present disclosure;

FIG. 6 shows a detail view of an induction coil in accordance with embodiments of the present disclosure;

FIG. 7 shows a detail view of an induction coil in accordance with embodiments of the present disclosure; and

FIG. 8 is a flow chart depicting a method of mounting a vehicle panel in accordance with embodiments of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

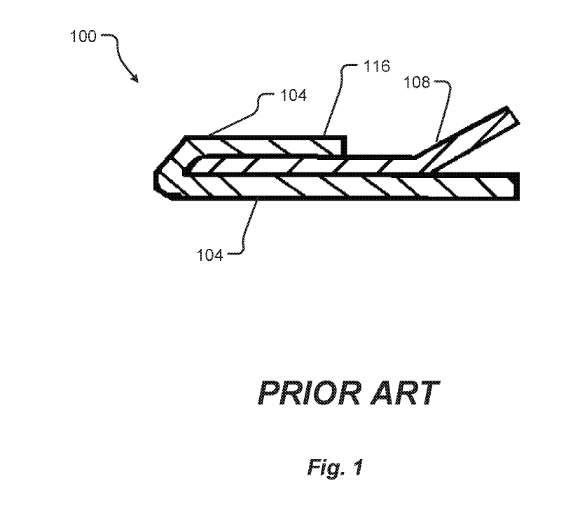

Traditionally, motor vehicle bodies are constructed by mounting sheet metal panels (e.g. A-class panels) to a vehicle body in white (“BIW”) (commonly referred to as a chassis). Contemporary methods of attaching panels to a BIW rely on a hemming process in which panels such as doors, hoods, fenders, tailgates, trunks, and deck lids are stamped out and then joined to a BIW by hemming a flange-over. Hemming involves physically bending a periphery of an outer panel over an edge of an inner panel on the BIW to secure the panels together. Hemming alone has been known not to be sufficient to fully secure an outer panel onto a vehicle BIW. In addition to hemming, vehicle manufacturers must use additional means of adhesion such as an arc, mig, or fusion weld at the hemmed edge. Some methods of hemming involve applying an adhesive or using a spot-weld technique. Methods of hemming as known in the art may be as illustrated in FIG. 1. As can be appreciated from FIG. 1, an edge portion of a body panel 104 may be bent around an edge portion of a vehicle chassis 108. This process of bending a portion of a vehicle outer panel 104 around an edge of a vehicle chassis 108 may result in a hemmed edge 100. An end, or lip, 116 of the vehicle outer panel 104 may lie on the inner portion of the vehicle chassis 108.

As discussed above, the hemming process results in a number of negative consequences ranging from excessive manufacturing costs, vehicle design limitations and constraints, an increased amount of time of manufacturing, an inefficient manufacturing timeline, an inefficient vehicle painting process, an unreliable joint strength, to a final product lacking aesthetic appeal.

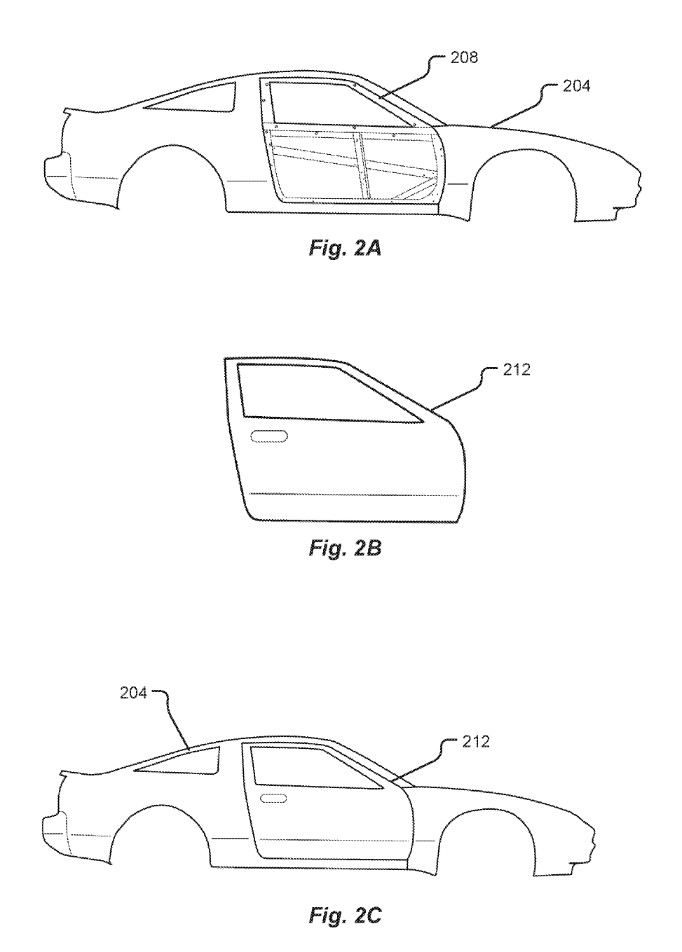

Disclosed herein is a process which eliminates the need for hemming in the joining of vehicle panels to a BIW. Systems and methods disclosed herein result in lower manufacturing costs, greater freedom in vehicle design, a decrease in the amount of time of manufacturing, a more efficient manufacturing timeline, a more efficient vehicle painting process, a more reliable joint strength, and a final product with greater aesthetic appeal. In some embodiments, a panel 212 may be mounted in a space 208 of a body in white 204 as illustrated in FIGS. 2A-2C. As shown in FIG. 2A, a vehicle chassis 204 may comprise a portion 208 onto which an outer panel 212 as illustrated in FIG. 2B may be fitted. In some embodiments, areas of the portion 208 may be applied with an adhesive before an outer panel 212 is placed onto the portion 208 of the chassis 204 as illustrated in FIG. 2C.

In some embodiments, vehicle panels, or A-class panels, may be sheet metal. For example, in some embodiments vehicle panels comprise aluminum or another metal.

In some embodiments, an A-class panel may be bonded to a BIW by an inductive curing process without requiring any hemming or other bending of the A-class panel material over any inner panel or over the BIW surface.

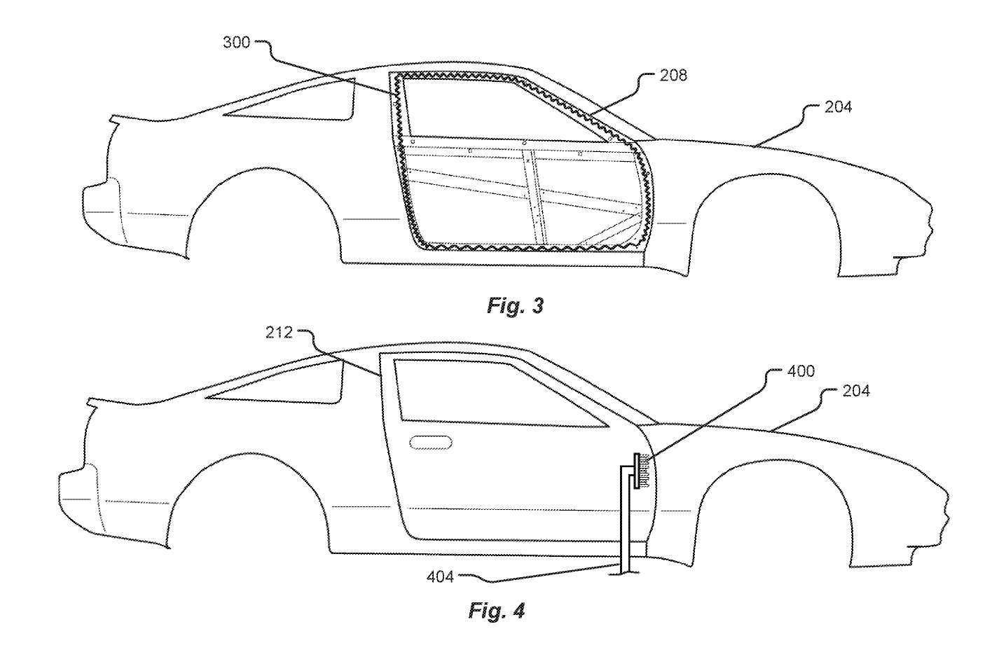

In some embodiments, an adhesive 300 may be used in the inductive curing process as illustrated in FIG. 3. In some embodiments, the adhesive 300 used in the process may be a specialized structural epoxy adhesive filled with beads. In some embodiments, the adhesive 300 may be applied around edges of the portion 208 of the chassis 204 onto which an outer panel may be fitted. For example, in some embodiments, glass beads 200-250 microns in diameter may be used. In some embodiments beads of other materials or other diameter may be used.

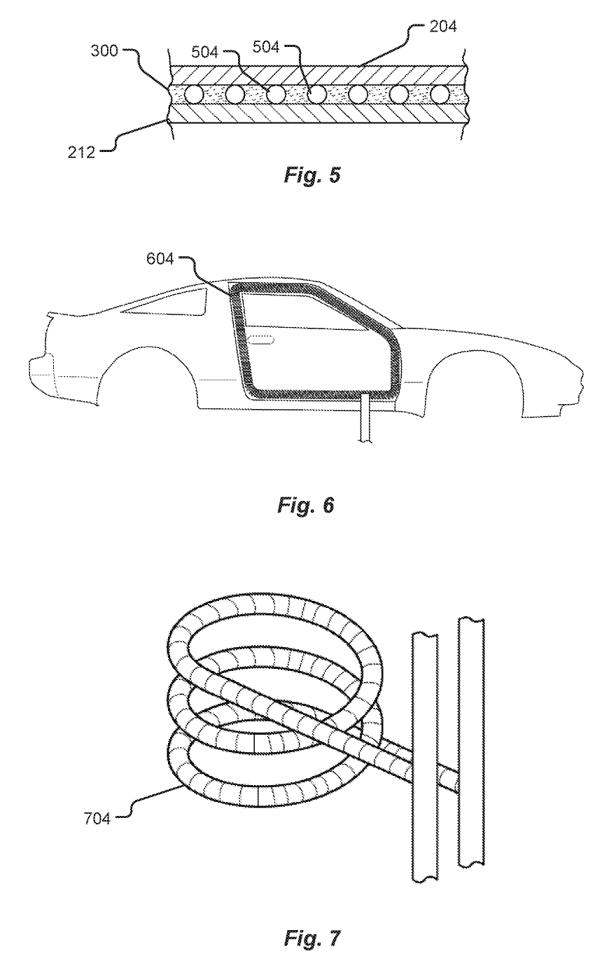

An objective of the inductive curing as disclosed herein is to join the metal surface of the inner side of an outer A-class panel to the metal surface of an inner panel on a BIW. By applying an adhesive comprising small, spherical beads, or particles interspersed within the adhesive, the outer, A-class panel may be held at a particular gap away from the inner panel of the BIW. The gap may be approximately the diameter of the beads within the adhesive. The gap may ensure a strong joint may be created through induction curing while avoiding read-through and the burning or escaping of the adhesive. In some embodiments, a gap between the chassis 204 and the panel 212 may be filled by adhesive 300 as illustrated in FIG. 5. The adhesive 300 may comprise one or more glass beads 504. In some embodiments, glass beads 504 in the adhesive 300 may dictate the distance between the chassis 204 and the panel 212.

When an outer panel is brought into contact with the adhesive applied to an inner panel, a force may be applied such as to disperse the beads within the adhesive and lessen the gap distance to approximately the diameter of the beads.

In some embodiments, the adhesive may be applied onto an inner panel. In some embodiments, the adhesive may be applied onto an inner surface of the outer panel.

After applying the adhesive, the outer panel (also known as A-class) may then be mounted onto the inner panel.

Beads in the adhesive may dictate a gap between the outer panel and the inner panel. The gap may be tuned to such a thickness as to ensure proper joining of the outer panel to the BIW.

After positioning an outer panel in contact with the adhesive applied to the inner panel of the BIW, an induction coil may then be used to create a magnetic field and apply heat and warm the adhesive. The heat applied by the induction coil may be adjusted such as to reduce or eliminate a possibility of the adhesive burning or read-through occurring (marring the outer panel of the vehicle) while also ensuring the adhesive is cured and a strong joint between the BIW and the outer panel is achieved. As illustrated in FIG. 4, a vehicle panel 212 may be placed on a vehicle chassis 204. An induction coil 400 may be positioned over portions of the vehicle panel 212 and heated such as to cure the adhesive. The induction coil 400 may be moved into position via a physical arm 404. In some embodiments, the induction coil 400 may be moved around the edges of the panel 212 in order to cure the adhesive around the panel 212. In some embodiments, the movement of the induction coil 400 may be automatically made via a robotic arm controlled by a computer.

In some embodiments, the induction coil may be custom formed for each vehicle panel to match the geometry or physical shape of the panel. In some embodiments, the coil 604 may be the shape of an outer vehicle panel as illustrated in FIG. 6. In some embodiments, the induction coil may be mounted on a moveable fixture such that the heat from the induction coil may be precisely managed. The fixture used for this process may incorporate an automated arm which may swing an induction curing equipment over the outer panel to a precise gap (such gap may depend on material type and thickness).

In some embodiments, a ceramic mold may be used to control a spacing, or gap, between the induction coil and the outer panel. In some embodiments, the coil may be covered by ceramic 704 as illustrated in FIG. 7. For example, the gap may in some embodiments be controlled via ceramic sheets which may touch the sheet-metal and encase copper tubing necessary for the induction curing equipment. The curing may in some embodiments be done in two ways: either spot curing or curing of the entire perimeter. By adjusting the amount of heat applied to the adhesive and the amount of spacing between the induction coil and the outer panel, the risk of read-through may be lowered or eliminated and the strength of the joint between the outer panel and the BIW may be confidently ensured.

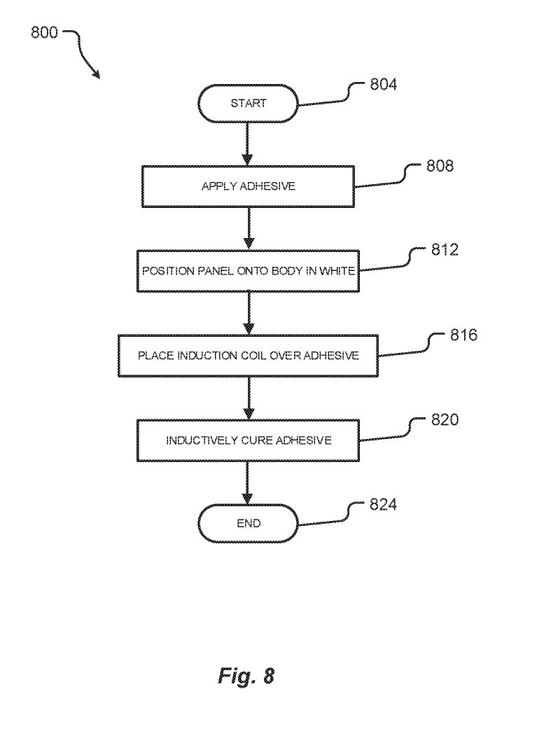

In some embodiments, a method 800 may be used to join the vehicle panel to the body in white as illustrated in FIG. 8. Such a method 800 may begin 804 and may comprise applying an adhesive 808 as discussed herein. The method may comprise, following the application of the adhesive 808, positioning a panel onto the body in white 812. After a panel has been positioned onto the body in white 812, the method may comprise placing an induction coil over the panel and specifically over the portions of the panel in contact with the adhesive 816. When the induction coil has been placed over the panel 816, the induction coil may be heated such as to inductively cure the adhesive 820, joining the panel to the body in white. The method may, after curing the adhesive 820, end 824.

Traditionally, assembling various parts in a vehicle during manufacturing, such as windows, electronics, etc., requires a vehicle to first be mounted with the outer panels due to the restrictions of the hemming process. This limitation is due in part to the fact that a vehicle manufactured using a hemming process must be painted only after the panels have been hemmed onto the BIW. As a result, contemporary methods of manufacturing vehicles involve factory workers fitting parts into the vehicle through small openings.

The methods presently disclosed, however, enable outer panels to be painted prior to being mounted on a BIW. As a result, the various parts discussed above, including windows, electronics, etc., may be mounted any time after a BIW has been e-coated. The outer panels may be painted separately and away from the vehicle. This change in the manufacturing timeline enables factory workers much greater access to the inner areas of a vehicle and allow for easier and more efficient manufacturing process.

Moreover, because the present disclosure allows A-class panels to be painted away from the vehicle and prior to being attached, the panels may be arranged in a cube or square shape to allow for maximum efficiency in the painting process. Furthermore, the present disclosure allows for a vehicle to essentially be completely manufactured before a color has been selected and before the outer panels are mounted onto the chassis. This benefit is provided only by the elimination of the need for hemming.

Any of the steps, functions, and operations discussed herein can be performed continuously and automatically.

The exemplary systems and methods of this disclosure have been described in relation to the figures. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a system for joining a vehicle body panel to a vehicle body in white, the system comprising: an adhesive applied to an inner panel of the body in white; the vehicle body panel pressed against the inner panel; and heat applied to the vehicle body panel, wherein the adhesive is inductively cured.

Aspects of the above system for joining a vehicle body panel to a vehicle body in white include wherein the heat is applied by an inductive coil.

Aspects of the above system for joining a vehicle body panel to a vehicle body in white include wherein the a gap between the inductive coil and the vehicle body panel is controlled by a ceramic sheet.

Aspects of the above system for joining a vehicle body panel to a vehicle body in white include wherein the vehicle body panel is painted prior to the pressing of the vehicle body panel to the inner panel.

Aspects of the above system for joining a vehicle body panel to a vehicle body in white include wherein the vehicle body panel is attached without hemming.

Aspects of the above system for joining a vehicle body panel to a vehicle body in white include wherein the adhesive comprises glass beads.

Aspects of the above system for joining a vehicle body panel to a vehicle body in white include wherein the glass beads dictate a gap between the vehicle body panel and the inner panel.

Embodiments include a method for joining a vehicle body panel with a body in white, the method comprising: applying an adhesive to an inner panel of the body in white; pressing the vehicle body panel to the inner panel; and applying heat to the vehicle body panel, wherein the adhesive is inductively cured.

Aspects of the above method for joining a vehicle body panel with a body in white include wherein the heat is applied by an inductive coil.

Aspects of the above method for joining a vehicle body panel with a body in white include wherein a gap between the inductive coil and the vehicle body panel is controlled by a ceramic sheet.

Aspects of the above method for joining a vehicle body panel with a body in white include wherein the vehicle body panel is painted prior to the pressing of the vehicle body panel to the inner panel.

Aspects of the above method for joining a vehicle body panel with a body in white include wherein the vehicle body panel is attached without hemming.

Aspects of the above method for joining a vehicle body panel with a body in white include wherein the adhesive comprises glass beads.

Aspects of the above method for joining a vehicle body panel with a body in white include wherein the glass beads dictate a gap between the vehicle body panel and the inner panel.

Embodiments include an inductive curing system for joining a vehicle body panel with a body in white, the inductive curing system comprising: an adhesive applied to an inner panel of the body in white; the vehicle body panel pressed against the inner panel; and heat applied to the vehicle body panel, wherein the adhesive is inductively cured.

Aspects of the above inductive curing system for joining a vehicle body panel with a body in white include wherein the heat is applied by an inductive coil.

Aspects of the above inductive curing system for joining a vehicle body panel with a body in white include wherein a gap between the inductive coil and the vehicle body panel is controlled by a ceramic sheet.

Aspects of the above inductive curing system for joining a vehicle body panel with a body in white include wherein the vehicle body panel is painted prior to the pressing of the vehicle body panel to the inner panel.

Aspects of the above inductive curing system for joining a vehicle body panel with a body in white include wherein the vehicle body panel is attached without hemming.

Aspects of the above inductive curing system for joining a vehicle body panel with a body in white include wherein the adhesive comprises glass beads.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A system for joining a vehicle body panel to a vehicle body in white, the system comprising:
an adhesive applied to an inner panel of the body in white;
the vehicle body panel pressed against the inner panel; and
heat applied to the vehicle body panel, wherein the adhesive is inductively cured.

2. The system of claim 1, wherein the heat is applied by an inductive coil.

3. The system of claim 2, wherein a gap between the inductive coil and the vehicle body panel is controlled by a ceramic sheet.

4. The system of claim 1, wherein the vehicle body panel is painted prior to the pressing of the vehicle body panel to the inner panel.

5. The system of claim 1, wherein the vehicle body panel is attached without hemming.

6. The system of claim 1, wherein the adhesive comprises glass beads.

7. The system of claim 6, wherein the glass beads dictate a gap between the vehicle body panel and the inner panel.

8. A method for joining a vehicle body panel with a body in white, the method comprising:
applying an adhesive to an inner panel of the body in white;
pressing the vehicle body panel to the inner panel; and
applying heat to the vehicle body panel, wherein the adhesive is inductively cured.

9. The method of claim 8, wherein the heat is applied by an inductive coil.

10. The method of claim 9, wherein a gap between the inductive coil and the vehicle body panel is controlled by a ceramic sheet.

11. The method of claim 8, wherein the vehicle body panel is painted prior to the pressing of the vehicle body panel to the inner panel.

12. The method of claim 8, wherein the vehicle body panel is attached without hemming.

13. The method of claim 8, wherein the adhesive comprises glass beads.

14. The method of claim 13, wherein the glass beads dictate a gap between the vehicle body panel and the inner panel.

15. An inductive curing system for joining a vehicle body panel with a body in white, the inductive curing system comprising:
an adhesive applied to an inner panel of the body in white;
the vehicle body panel pressed against the inner panel; and
heat applied to the vehicle body panel, wherein the adhesive is inductively cured.

16. The inductive curing system of claim 15, wherein the heat is applied by an inductive coil.

17. The inductive curing system of claim 16, wherein a gap between the inductive coil and the vehicle body panel is controlled by a ceramic sheet.

18. The inductive curing system of claim 15, wherein the vehicle body panel is painted prior to the pressing of the vehicle body panel to the inner panel.

19. The inductive curing system of claim 15, wherein the vehicle body panel is attached without hemming.

20. The inductive curing system of claim 15, wherein the adhesive comprises glass beads.
